(19) United States
(12) Patent Application Publication
(10) Pub. No.: US 2021/0166563 A1
(43) Pub. Date: Jun. 3, 2021

(54) MOTOR VEHICLE, COMPRISING AN APPARATUS FOR OUTPUTTING AN AUDIO SIGNAL TO A PASSENGER COMPARTMENT OF THE MOTOR VEHICLE

(71) Applicant: ASK Industries GmbH, Niederwinkling (DE)

(72) Inventor: Srinidhi Sadashiva Marathe, Niederwinkling (DE)

(73) Assignee: ASK Industries GmbH, Niederwinkling (DE)

(21) Appl. No.: 17/253,255

(22) PCT Filed: Jun. 18, 2018
(86) PCT No.: PCT/EP2018/066143

§ 371 Date: Dec. 17, 2020

(51) Int. Cl. G08G 1/16; G10K 11/18; G01S 13/931; G01S 17/931

(52) U.S. Cl. CPC G08G 1/166; G01S 17/931; G01S 13/931; G10K 11/18

(57) ABSTRACT

Motor vehicle (1), comprising a device (2) for outputting an audio signal (3) into a passenger compartment (4) of the motor vehicle (1), which comprises: an audio output apparatus (5) comprising a plurality of audio output elements (5a-5d) arranged in the passenger compartment (4) of the motor vehicle (1) for outputting an audio signal (3) into the passenger compartment (4) of the motor vehicle (1), a control apparatus (6) for controlling the output of the audio signal (3) via respective audio output elements (5a-5d), with the control apparatus (6) being configured to control the output of an audio signal (3) into the passenger compartment (4) of the motor vehicle (1) based on movement information describing a movement of at least one object (7), in particular a road user, relative to the motor vehicle (1).

### CROSS REFERENCE TO RELATED APPLICATIONS

The present specification is a National Phase Entry of International Application No. PCT/EP 2018/066143 filed 18 Jun. 2018 and entitled “Motor Vehicle, Comprising An Apparatus For Outputting An Audio Signal To A Passenger Compartment Of The Motor Vehicle” the entirety of which is incorporated by reference herein.

### FIELD

The present specification relates to a motor vehicle, comprising a device for outputting an audio signal into a passenger compartment of the motor vehicle, which comprises an audio output apparatus comprising a plurality of audio output elements arranged in a passenger compartment of the motor vehicle for outputting an audio signal into the passenger compartment of the motor vehicle and a control apparatus assignable or assigned to the audio output apparatus for controlling the output of the audio signal that can be output via respective audio output elements, in particular for controlling at least one output parameter of the audio signal that can be output via respective audio signal elements.

### TECHNICAL BACKGROUND

Motor vehicles, i.e. in particular passenger vehicles with corresponding devices for outputting audio signals or content into the passenger compartment have been long known. The object and function of corresponding devices is typically to provide the passenger(s) with audio signals or content during use of the motor vehicle, for example for the purposes of information, communication or entertainment.

In light of the continuous drive to further develop driving safety of motor vehicles, there is a need for technically expedient considerations to expand the functional scope of corresponding devices, in particular in relation to already present on-board assistance or safety systems, which enable monitoring of the environment around the motor vehicle, in particular in the aspect of possible driving safety-related situations so that the output of audio signals taking place via corresponding devices into the passenger compartment can also be used for driving safety-related or technical purposes.

### SUMMARY

The object underlying the present specification is to indicate a motor vehicle with a device for outputting audio signals into the passenger compartment of the motor vehicle, whose functional scope is expanded, in particular in regard to driving safety-related or technical purposes.

The object is achieved by a motor vehicle, comprising a device for outputting an audio signal into the passenger compartment of the motor vehicle according to claim 1. The dependent claims in this regard relate to possible embodiments of the motor vehicle.

The motor vehicle described herein, it is in this case in particular a passenger vehicle, comprises a device for outputting one or a plurality of audio signals into the passenger compartment of the motor vehicle. The device can form a functional part of an on-board multimedia apparatus for outputting multimedia signals or content into the passenger compartment of the motor vehicle. By means of the device, music and/or voice signals can in particular be output into the passenger compartment of the motor vehicle. An audio signal is therefore in particular understood as a music and/or voice signal; an audio signal can therefore contain audio content such as music and/or voice. As described further below, an audio signal can, however, also be understood as a movement information signal which contains audio content other than music and/or voice, i.e. no music and/or voice. Irrespective of its specific content, an audio signal typically contains a plurality of audio signal parts, i.e. e.g. high, mid, low, definable or defined by certain frequencies or frequency ranges.

The device comprises an audio output apparatus for outputting one or a plurality of audio signals into the passenger compartment of the motor vehicle. The audio output apparatus implemented via hardware and/or software is therefore configured to process at least one audio signal provided e.g. via a physical or non-physical audio signal source in regard to an output of the same into the passenger compartment of the motor vehicle. The audio output apparatus comprises a plurality of audio output elements arranged in the passenger compartment of the motor vehicle. The audio output elements are typically arranged in different regions of the passenger compartment in order to output the at least one audio signal from different regions of the passenger compartment and therefore from different output apparatuses into the passenger compartment. At least one audio output element is typically arranged in the region left of the longitudinal (middle) axis of the motor vehicle and at least one audio output element in the region right of the longitudinal (middle) axis of the motor vehicle. Audio output elements arranged correspondingly left of the longitudinal (middle) axis of the motor vehicle can be arranged in front of or behind a transverse (middle) axis of the motor vehicle, i.e. in the region of the front or of the rear of the motor vehicle. Audio output elements also arranged correspondingly right of the longitudinal (middle) axis of the motor vehicle can be arranged in front of or behind a transverse (middle) axis of the motor vehicle, i.e. in the region of the front or of the rear of the motor vehicle. Of course, at least one audio output element can also be arranged in the region of the longitudinal (middle) axis and/or in the region of the transverse (middle) axis of the motor vehicle.

The operation of the audio output elements can be controlled dependent on or independent of one another. This is in particular understood to mean that the audio output elements can be put into or taken out of operation dependent on or independent of one another. However, this is also understood to mean that the audio output elements can be operated dependent on or independently of one another with identical or different audio output parameters, such as e.g. intensity or volume dependent on or independent of one another.

The audio output elements can in particular be designed as speaker elements comprising at least one speaker or can comprise such.

The device also comprises a control apparatus implemented via hardware and/or software assignable or assigned to the audio output apparatus. The control apparatus is configured to control the output of at least one audio signal via respective audio output elements. The control apparatus is configured to control at least one audio output parameter of the at least one audio signal that can be output via respective audio output elements. As mentioned, an audio output parameter can e.g. be the intensity of the audio signal to be output or output.

The control apparatus is configured to control the output of an audio signal into the passenger compartment of the motor vehicle based on movement information describing a movement of at least one object, i.e. in particular another road user such as e.g. another motor vehicle, relative to the motor vehicle. The output of an audio signal into the passenger compartment of the motor vehicle, i.e. in particular the output direction of the audio signal, understood here is in particular the output direction of the audio signal output into the passenger compartment acoustically felt or perceived by a passenger located in the passenger compartment, can therefore be controlled based on the movement information describing a detected movement of an object located in the environment around the motor vehicle relative to the motor vehicle. The control apparatus is therefore configured to generate control parameters to control the output of at least one audio signal to be output into the passenger compartment, which imparts to a vehicle passenger an acoustically perceivable connection between an object located in the environment around the motor vehicle and moving relative to the motor vehicle or the movement of the object located in the environment around the motor vehicle relative to the motor vehicle and the motor vehicle itself and to perform the output of the at least one audio signal based on the control parameters. The correspondingly controlled output of the at least one audio signal therefore represents any objects located in the environment around the motor vehicle and moving relative to the motor vehicle. The mentioned, acoustically perceivable connection between objects located in the environment around the motor vehicle and moving relative to the motor vehicle or corresponding objects relative to the motor vehicle and the motor vehicle is therefore imparted to a vehicle passenger via the particular control of the output of the audio signal. This takes place independent of the actual content of the audio signal to be output only via the control of the output or the output direction of the audio signal; the actual content of the audio signal is therefore not changed.

The control of the output of the at least one audio signal, i.e. in particular the control of the output direction of the at least one audio signal can therefore be imparted to a vehicle passenger in the sense of acoustically perceivable feedback that an object located in the environment around the motor vehicle is moving relative to the motor vehicle. Consequently, the control of the at least one audio signal can, in addition to the actual purpose of playing respective audio content represented by the audio signal, which, as mentioned, can for example be music and/or voice, which is typically also provided during the control of the output of the audio signal, can therefore also be used through targeted control of the output direction to impart to a vehicle passenger, i.e. in particular the driver, the best possible information about the objects located in the environment around the motor vehicle and moving relative to the motor vehicle.

In particular, objects not visible to a vehicle passenger e.g. due to a certain relative position to the vehicle, may be acoustically perceivable to the vehicle passenger through corresponding control of the output of the at least one audio signal such that the vehicle passenger, i.e. in particular the driver, through a targeted control of the output of the at least one audio signal taking place by means of the control apparatus, i.e. in particular a targeted control of the output direction of the at least one audio signal taking place by means of the control apparatus, is notified about non-visible objects in the environment around the motor vehicle. The control can e.g. carry out a targeted change of the output of the at least one audio signal, i.e. in particular a targeted change of the output direction of the at least one audio signal, on the basis of which a vehicle passenger can be notified about a non-visible object in the environment around the motor vehicle. As described further below, there is typically an acoustically perceivable connection between the position of the object relative to the motor vehicle and the control of the output direction of the audio signal. There can also be an acoustically perceivable connection between movements of the object relative to the motor vehicle and a change of the output direction of the audio signal.

Driving safety-related aspects about the object situation in the environment around the motor vehicle can therefore be imparted to the vehicle passenger, i.e. in particular to the driver, via the dynamically or variably controllable or controlled output of the audio signal, i.e. in particular the dynamically or variably controllable or controlled change of the output direction of the audio signal based on the object situation in the environment around the motor vehicle, i.e. in particular based on the movements of objects relative to the vehicle. The functional scope of the device is therefore expanded in regard to driving safety-related or technical purposes.

The audio output apparatus can be configured to output at least two different audio signals, in particular in parallel or at the same time, into the passenger compartment of the motor vehicle. Irrespective of its specific content, respective first and second audio signals can be output via identical or different audio output elements and/or using identical or differing audio output parameters.

A first audio signal can e.g. be a music or voice signal. A second audio signal can be in particular an artificially generated movement information signal which contains audio content other than music and/or voice, i.e. no music and/or voice. A movement information signal can be e.g. in the form of a tone or a tone sequence of a certain frequency or a certain frequency range, indicate or describe a movement of at least one object, in particular another road user, relative to the motor vehicle. A movement information signal may therefore be an audio signal which is generated separately or additionally and output additionally with respect to an already output audio signal, i.e. e.g. a music or voice signal, which serves to indicate to a vehicle passenger a movement of at least one object, in particular a road user, relative to the motor vehicle. A movement information signal can therefore (only) be generated and/or output, in particular in contrast to a music and/or voice signal, when an object moving relative to the motor vehicle has been detected.

A movement information signal can in particular be generated via the control apparatus; the control apparatus can therefore (also) be configured to generate a corresponding movement information signal.

The control apparatus can also be configured to control at least the output of a corresponding movement information signal into the passenger compartment of the motor vehicle based on the movement information describing a movement of at least one object, in particular a road user, relative to the motor vehicle.

Consequently, the output or control of the output of a corresponding movement information signal, i.e. in particular the control of the output direction of the movement information signal can also be imparted to a vehicle passenger in the sense of acoustically perceivable feedback that an object located in the environment around the motor vehicle is moving relative to the motor vehicle. As a result, the targeted control of the output direction of the movement information signal can also be used to impart to a vehicle passenger, i.e. in particular the driver, the best possible information about objects located in the environment around the motor vehicle and moving relative to the motor vehicle.

Of course, the output of a plurality of different audio signals, i.e. in particular of a corresponding movement information signal and a further audio signal, such as e.g. a music and/or voice signal can also in each case be controlled based on the movement information describing a movement of at least one object, in particular a road user, relative to the motor vehicle.

For all types of audio signals to be output or output, they can be output with a certain audio effect representing in particular the movement of a detected object moving relative to the motor vehicle. A corresponding audio effect can e.g. be an (artificially generated) Doppler effect. The effects can also be generated by the control apparatus; the control apparatus can therefore be configured to generate audio effects representing in particular the movement of a detected object moving relative to the motor vehicle.

The control apparatus can be assignable or assigned to at least one on-board detection apparatus implemented via hardware and/or software, which is configured to detect a movement of at least one object relative to the motor vehicle and to generate (the) movement information describing a movement of at least one detected object relative to the motor vehicle. A corresponding detection apparatus can also be configured for distance or speed measurement. A corresponding detection apparatus can form a part of an on-board assistance or safety system, i.e. e.g. a longitudinal and/or transverse guidance system, parking system etc. In particular, a corresponding detection apparatus can form a part of an assistance system enabling a partially or fully autonomous drive operation of the motor vehicle. A corresponding assistance or safety system can have suitable e.g. acoustic and/or optical detection elements, i.e. e.g. acoustic and/or optical sensor elements, which are configured to detect objects in the environment around the motor vehicle or to detect the movement of objects in the environment around the motor vehicle. Corresponding detection elements can e.g. be designed as ultrasonic elements, laser elements, lidar elements, radar elements, etc. Other configurations are conceivable.

A corresponding detection apparatus can be configured to generate a detection region at least in sections, in particular fully surrounding the motor vehicle, in which a movement of at least one object relative to the motor vehicle can be detected. In particular, a corresponding detection apparatus can be configured to detect the entry or the entry position and the exit or the exit position of corresponding objects into the or from the detection region. Of course, movements of an object occurring in the detection region can typically also be detected within the detection region.

The detection region, i.e. in particular its alignment, shape and size, are typically based on the manner, arrangement and mode of operation of the detection apparatus or the detection elements belonging thereto. It is conceivable that through one or a plurality of detection apparatuses or elements a detection region fully surrounding the motor vehicle can be formed. The motor vehicle is typically located within, i.e. in particular in the middle point of a corresponding detection region.

A corresponding detection apparatus can be configured to detect objects moving relative to the motor vehicle, i.e. in particular road users, such as e.g. other vehicles, cyclists, pedestrians, animals, etc. In particular, the detection apparatus can be configured to detect objects moving in the same or opposing direction to the motor vehicle, i.e. in particular road users, such as e.g. other vehicles, cyclists, pedestrians, animals, etc.

Object situations around the motor vehicle described by way of example with corresponding movement information are explained as an example of possibilities of control of the output or the output direction of the audio signal into the passenger compartment of the motor vehicle perceivable or perceived by means of the control apparatus.

The control apparatus can be configured, in particular for the case of an object moving right of the motor vehicle, to control or carry out the output of an audio signal to be output based on movement information describing a movement of an object moving right of the motor vehicle via at least one audio output element arranged right of the longitudinal middle axis of the motor vehicle, in particular via all audio output elements arranged right of the longitudinal middle axis of the motor vehicle. In particular, the control apparatus can be configured to control or carry out the output of an audio signal based on movement information describing a movement of an object moving right of the motor vehicle via at least one audio output element arranged right of the longitudinal middle axis of the motor vehicle, in particular via all audio output elements arranged right of the longitudinal middle axis of the motor vehicle, with a comparatively higher intensity than via at least one audio output element arranged left of the longitudinal middle axis of the motor vehicle, in particular via all audio output elements arranged left of the longitudinal middle axis of the motor vehicle. It can therefore be imparted in an acoustically perceivable manner to the vehicle passenger via an output of the audio signal taking place in this case and for this case via one or a plurality of audio output elements arranged right of the longitudinal middle axis of the motor vehicle that an object (typically in relation to the direction of travel of the motor vehicle) is located right of the motor vehicle and is moving relative to the motor vehicle. The same can also be implemented, if necessary, with a comparatively lower intensity.

The control apparatus can, analogously, be configured, in particular for the case of an object moving left of the motor vehicle, to control or carry out the output of an audio signal to be output based on movement information describing a movement of an object moving left of the motor vehicle via at least one audio output element arranged left of the longitudinal middle axis of the motor vehicle, in particular via all audio output elements arranged left of the longitudinal middle axis of the motor vehicle. In particular, the control apparatus can be configured to control or carry out the output of an audio signal based on movement information describing a movement of an object moving left of the motor vehicle via at least one audio output element arranged left of the longitudinal middle axis of the motor vehicle, in particular via all audio output elements arranged left of the longitudinal middle axis of the motor vehicle, with a comparatively higher intensity than via at least one audio output element arranged right of the longitudinal middle axis of the motor vehicle, in particular via all audio output elements arranged right of the longitudinal middle axis of the motor vehicle. It can therefore be imparted in an acoustically perceivable manner to the vehicle passenger via the output of the audio signal taking place in this case and for this case via one or a plurality of audio output elements arranged left of the longitudinal middle axis of the motor vehicle that an object (typically in relation to the direction of travel of the motor vehicle) is located left of the motor vehicle and is moving relative to the motor vehicle. The same can also be implemented, if necessary, with a comparatively lower intensity.

The control apparatus can be configured, in particular for the case of an object moving towards the front of the motor vehicle, to control or carry out the output of an audio signal to be output based on movement information describing a movement of an object moving towards the front of the motor vehicle via at least one audio output element arranged in front of a transverse middle axis of the motor vehicle and therefore in the region of the front of the motor vehicle, in particular via all audio output elements arranged in front of the transverse middle axis. In particular, the control apparatus can be configured to control or carry out the output of an audio signal based on movement information describing a movement of an object moving towards the front of the motor vehicle via at least one audio output element arranged in front of the transverse middle axis of the motor vehicle, in particular via all audio output elements arranged in the front of the transverse middle axis, with a higher intensity compared to a predefinable or predefined reference intensity than via at least one audio output element arranged behind the transverse middle axis of the motor vehicle and therefore in the region of the rear of the motor vehicle, in particular via all audio output elements arranged behind the transverse axis of the motor vehicle. It can therefore be imparted in an acoustically perceivable manner to the vehicle passenger via the output of the audio signal taking place in this case and for this case via one or a plurality of audio output elements arranged in front of the transverse middle axis of the motor vehicle that an object (typically in relation to the direction of travel of the motor vehicle) is located in front of the transverse middle axis of the motor vehicle and is moving towards the front of the motor vehicle. It is also the case here that the same can be implemented, if necessary, also with a comparatively lower intensity. Equally, the output of the audio signal could take place conversely initially via an audio output element arranged behind the transverse middle axis of the motor vehicle and therefore in the region of the rear of the motor vehicle, in particular via all audio output elements arranged behind the transverse middle axis.

The control apparatus can be configured, in particular for the case of an object moving away from the motor vehicle, to control or carry out the output of an audio signal to be output based on movement information describing a movement of an object moving away from the motor vehicle via at least one audio output element arranged behind a transverse middle axis of the motor vehicle and therefore in the region of the rear of the motor vehicle, in particular via all audio output elements arranged behind a transverse middle axis. In particular, the control apparatus can be configured to control or carry out the output of an audio signal based on movement information describing a movement of an object moving away from the motor vehicle via at least one audio output element arranged behind the transverse middle axis of the motor vehicle, in particular via all audio output elements arranged behind the transverse middle axis, with a higher intensity compared to a predefinable or predefined reference intensity than via at least one audio output element arranged in front of the transverse middle axis of the motor vehicle and therefore in the region of the front of the motor vehicle, in particular via all audio output elements arranged in front of the transverse axis of the motor vehicle. It can therefore be imparted in an acoustically perceivable manner to the vehicle passenger via the output of the audio signal taking place in this case and for this case via one or a plurality of audio output elements arranged behind the transverse middle axis of the motor vehicle that an object (typically in relation to the direction of travel of the motor vehicle) is located behind the transverse middle axis of the motor vehicle and is moving away from the motor vehicle. It is also the case here that the same can be implemented, if necessary, also with a comparatively lower intensity. Equally, the output of the audio signal could take place conversely initially via an audio output element arranged in front of the transverse middle axis of the motor vehicle and therefore in the region of the front of the motor vehicle, in particular via all audio output elements arranged in front of the transverse middle axis.

The control apparatus can be configured in particular for the case of an object moving from the left towards the vehicle (in relation to the direction of travel of the motor vehicle) to control the output of an audio signal to be output based on movement information describing a movement of an object moving in the direction of travel from the left towards the motor vehicle such that the audio signal initially, in particular prior to passing of the motor vehicle, can be output or is output only via at least one audio output element arranged in the direction of travel in front of the transverse middle axis and left of the longitudinal middle axis of the motor vehicle, in particular via all audio output elements arranged in the direction of travel in front of the transverse middle axis and left of the longitudinal middle axis of the motor vehicle therefore, in particular during passing of the motor vehicle, via at least one audio output element arranged in front of the transverse middle axis and at least one audio output element arranged behind the transverse middle axis and left of the longitudinal middle axis of the motor vehicle, in particular via all audio output elements arranged in front of or behind the transverse middle axis and left of the longitudinal middle axis of the motor vehicle and lastly, in particular after passing of the motor vehicle, only via at least one audio output element arranged in the direction of travel behind the transverse middle axis and left of the longitudinal middle axis of the motor vehicle, in particular via all audio output elements arranged in the direction of travel behind the transverse middle axis and left of the longitudinal middle axis of the motor vehicle. Through the changing output of the audio signal representing the movement of the object relative to the motor vehicle, i.e. in particular the left-side passing of the motor vehicle by the object, it can be imparted in an acoustically perceivable manner to the vehicle passenger that an object is moving from the left towards the motor vehicle, is passing the motor vehicle on the left and is moving away from the motor vehicle. Equally, the output of the audio signal could take place conversely initially via an audio output element arranged behind the transverse middle axis of the motor vehicle and therefore in the region of the rear of the motor vehicle, in particular via all audio output elements arranged behind the transverse middle axis.

The control apparatus can be analogously configured in particular for the case of an object moving from the right towards the vehicle (in relation to the direction of travel of the motor vehicle) to control the output of an audio signal to be output based on movement information describing a movement of an object moving in the direction of travel from the right towards the motor vehicle such that the audio signal initially, in particular prior to passing of the motor vehicle, can be output or is output only via at least one audio output element arranged in the direction of travel in front of the transverse middle axis and right of the longitudinal middle axis of the motor vehicle, in particular via all audio output elements arranged in the direction of travel in front of the transverse middle axis and right of the longitudinal middle axis of the motor vehicle therefore, in particular during passing of the motor vehicle, via at least one audio output element arranged in front of the transverse middle axis and at least one audio output element arranged behind the transverse middle axis and right of the longitudinal middle axis of the motor vehicle, in particular via all audio output elements arranged in front of or behind the transverse middle axis and right of the longitudinal middle axis of the motor vehicle and lastly, in particular after passing of the motor vehicle, only via at least one audio output element arranged in the direction of travel behind the transverse middle axis and right of the longitudinal middle axis of the motor vehicle, in particular via all audio output elements arranged in the direction of travel behind the transverse middle axis and right of the longitudinal middle axis of the motor vehicle. Through the changing output of the audio signal representing the movement of the object relative to the motor vehicle, i.e. in particular the right-side passing of the motor vehicle by the object, it can be imparted in an acoustically perceivable manner to the vehicle passenger that an object is moving from the right towards the motor vehicle, is passing the motor vehicle on the right and is moving away from the motor vehicle. Equally, the output of the audio signal could take place conversely initially via an audio output element arranged in front of the transverse middle axis of the motor vehicle and therefore in the region of the front of the motor vehicle, in particular via all audio output elements arranged in front of the transverse middle axis.

On the basis of the above-mentioned exemplary control of the output of the audio signal, it should be understood that individual, a plurality, or all control possibilities of the output of an audio signal can be combined with one another as desired.

The control apparatus can also be configured to represent, in an acoustically perceivable manner to a vehicle passenger, left and right overtake operations of the motor vehicle itself, i.e. situations in which the motor vehicle itself overtakes an object, through a targeted control of the output or the output direction of an audio signal to be output.

The control apparatus can therefore be configured in particular for a left overtake operation of the motor vehicle, to control the output of an audio signal based on a movement of an object to be overtaken or overtaken on the left by the motor vehicle such that the audio signal initially, in particular prior to passing of the object to be overtaken on the left, is output only via at least one audio output element arranged in the direction of travel in front of the transverse middle axis and left of the longitudinal middle axis of the motor vehicle, in particular via all audio output elements arranged in the direction of travel in front of the transverse middle axis and left of the longitudinal middle axis of the motor vehicle therefore, in particular during passing of the object to be overtaken, via at least one audio output element arranged in front of and at least one audio output element arranged behind the transverse middle axis and left of the longitudinal middle axis of the motor vehicle, in particular via all audio output elements arranged in front of or behind the transverse middle axis and left of the longitudinal middle axis of the motor vehicle and lastly, in particular after passing of the object to be overtaken, only via at least one audio output element arranged in the direction of travel behind the transverse middle axis and left of the longitudinal middle axis of the motor vehicle, in particular via all audio output elements arranged in the direction of travel behind the transverse middle axis and left of the longitudinal middle axis of the motor vehicle. Equally, the output of the audio signal could take place conversely initially via an audio output element arranged behind the transverse middle axis of the motor vehicle, in particular via all audio output elements arranged behind the transverse middle axis and lastly via an audio output element arranged in front of the transverse middle axis, in particular via all audio output elements arranged in front of the transverse middle axis.

The control apparatus can therefore analogously be configured in particular for a right overtake operation of the vehicle to control the output of an audio signal based on an object to be overtaken or overtaken by the motor vehicle on the right such that the audio signal initially, in particular prior to passing of the object to be overtaken on the right, is output only via at least one audio output element arranged in the direction of travel in front of the transverse middle axis and right of the longitudinal middle axis of the motor vehicle, in particular via all audio output elements arranged in the direction of travel in front of the transverse middle axis and right of the longitudinal middle axis of the motor vehicle therefore, in particular during passing of the object to be overtaken, via at least one audio output element arranged in front of and at least one audio output element arranged behind the transverse middle axis and right of the longitudinal middle axis of the motor vehicle, in particular via all audio output elements arranged in front of or behind the transverse middle axis and right of the longitudinal middle axis of the motor vehicle and lastly, in particular after passing of the object to be overtaken, only via at least one audio output element arranged in the direction of travel behind the transverse middle axis and right of the longitudinal middle axis of the motor vehicle, in particular via all audio output elements arranged in the direction of travel behind the transverse middle axis and right of the longitudinal middle axis of the motor vehicle. Equally, the output of the audio signal could take place conversely initially via an audio output element arranged behind the transverse middle axis of the motor vehicle, in particular via all audio output elements arranged behind the transverse middle axis and lastly via an audio output element arranged in front of the transverse middle axis, in particular via all audio output elements arranged in front of the transverse middle axis.

Generally, i.e. even for all described examples, the control apparatus can be configured to uninterruptedly perform a change of the output of an audio signal taking place or carried out as part of the control of the output of an audio signal from an output of the audio via at least one first audio output element to an output of the audio signal via at least one second audio output element. The change of the output of the audio signal can therefore in particular take place or be carried out by so-called fading, i.e. a continuous change of intensity, i.e. an increase in intensity or reduction in intensity from a first intensity value to a second intensity value. In this manner, the dynamic of the dynamic of the actual object situation represented by the change of the output of the audio signal can be notably more acoustically perceivable to a vehicle passenger.

Object or traffic situations may arise in which objects located left and right of the motor vehicle are moving towards or away from the motor vehicle. The control apparatus can, in particular for such cases, be configured to control the output of an audio signal to be output based on an object moving in the direction of travel from the left towards or away from the motor vehicle and an object moving from the right towards or away from the motor vehicle such that the output of the audio signals takes place prioritized via left or right of the longitudinal middle axis of the motor vehicle. The prioritization can take place e.g. based on a classification of the objects. To this end, the motor vehicle can comprise a classification apparatus implemented via hardware and/or software which can form a part of the control apparatus. The classification can take place based on detected object parameters, such as e.g. type, size, speed, acceleration, etc. of the object. It is also conceivable that the classification takes into account conditions of traffic law, such as e.g. left or right traffic.

The movement information can describe an acceleration or speed or an associated movement value of an object moving relative to the motor vehicle. In this case, the control apparatus can be configured to control the output of an audio signal into the passenger compartment of the motor vehicle based on an acceleration or speed or an associated movement value describing the movement information in particular such that, in regard to a predefinable or predefined reference acceleration or speed, higher accelerations or speeds of an object moving relative to the motor vehicle are output with an output of audio signals with a higher intensity compared to a predefinable or predefined reference intensity. In this manner, accelerations, speeds and associated movement values of detected objects can also be represented, in an acoustically perceivable manner, to a vehicle passenger. The same applies to changing accelerations, speeds and associated movement values of detected objects.

The present specification also relates, in addition to the motor vehicle, to a device for outputting at least one audio signal into a passenger compartment of a motor vehicle, in particular of a motor vehicle described herein. The device comprises an audio output apparatus comprising a plurality of audio output elements arrangeable or arranged in a passenger compartment of a motor vehicle for outputting at least one audio signal into a passenger compartment of a motor vehicle, a control apparatus assignable or assigned to the audio output apparatus for controlling the output of at least one audio signal via respective audio output elements, in particular for controlling at least one output parameter of the at least one audio signal that can be output via respective audio signal elements. The control apparatus is configured to control the output of the at least one audio signal, in particular into a passenger compartment of a motor vehicle equipped with the device, based on movement information describing a movement of at least one object, in particular a road user, relative to a motor vehicle equipped with the device.

Moreover, the present specification relates to a method for outputting at least one audio signal into a passenger compartment of a motor vehicle, in particular of a motor vehicle described herein. According to the method, control of the output of the at least one audio signal into the passenger compartment takes place based on movement information describing a movement of at least one object, in particular a road user, relative to a motor vehicle equipped with the device.

All embodiments in relation to the motor vehicle, i.e. in particular also the embodiments relating to the subject matters of the dependent claims apply analogously to the device and to the method.

### BRIEF DESCRIPTION OF THE DRAWINGS

The embodiments of the present specification are explained in more detail below in relation to the exemplary embodiments represented in the drawings, in which is shown:

FIG. 1 is a main representation of a motor vehicle according to one exemplary embodiment;

FIG. 2 is a main representation of an object situation in the environment around the motor vehicle shown in FIG. 1;

FIG. 3 is a main representation of an object situation in the environment around the motor vehicle shown in FIG. 1;

FIG. 4 is a main representation of an object situation in the environment around the motor vehicle shown in FIG. 1;

FIG. 5 is a main representation of an object situation in the environment around the motor vehicle shown in FIG. 1; and

FIG. 6 is a main representation of a motor vehicle according to a further exemplary embodiment.

### DETAILED DESCRIPTION

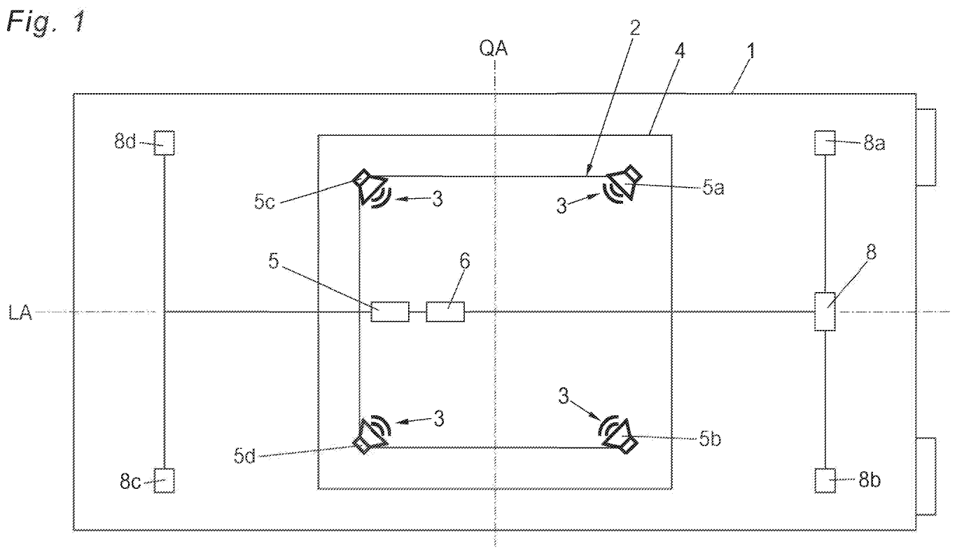

FIG. 1 shows a main representation of a motor vehicle 1 according to a first exemplary embodiment in a top view.

The motor vehicle 1 comprises a device 2 for outputting one or a plurality of audio signals 3 into the passenger compartment 4 of the motor vehicle 1. The device 2 can form a functional part of an on-board multimedia apparatus (not shown) for outputting multimedia signals or content into the passenger compartment 4. By means of the device 2, music and/or voice signals can in particular be output; audio signals 3 are therefore in particular to be understood as music and/or voice signals; the audio signal 3 can therefore contain audio content such as music and/or voice.

The device 2 comprises an audio output apparatus 5 for outputting one or a plurality of audio signals 3 into the passenger compartment 4 of the motor vehicle 1. The audio output apparatus 5 implemented via hardware and/or software is configured to process at least one audio signal 3 provided via a physical or non-physical audio signal source (not shown) to output the audio signal 3 into the passenger compartment 4. The audio output apparatus 5 comprises a plurality of audio output elements 5a-5d arranged in the passenger compartment 4. The audio output elements 5a-5d are arranged in different regions of the passenger compartment 4 in order to output the audio signal 3 from different regions of the passenger compartment 4 into the passenger compartment 4. The audio output elements 5a-5d are each designed as a speaker element comprising at least one speaker.

In the exemplary embodiment according to FIG. 1, four audio output elements 5a-5d are shown purely as an example. Two audio output elements 5a, 5b are arranged in front of the transverse middle axis QA of the motor vehicle 1, i.e. in the region of the front of the motor vehicle 1, with the audio output element 5a being arranged left of the longitudinal middle axis LA of the motor vehicle 1 and the audio output element 5b right of the longitudinal middle axis LA of the motor vehicle 1. Two further audio output elements 5c, 5d are arranged behind the transverse middle axis QA of the motor vehicle 1, i.e. in the region of the rear of the motor vehicle 1, with the audio output element 5c being arranged left of the longitudinal middle axis LA of the motor vehicle 1 and the audio output element 5d right of the longitudinal middle axis LA of the motor vehicle 1. Of course, further audio output elements could e.g. also be arranged in the region of the longitudinal middle axis LA and/or in the region of the transverse middle axis QA of the motor vehicle 1.

The operation of the audio output elements 5a-5d can be controlled dependent on or independent of one another. The audio output elements 5a-5d can therefore be put into or taken out of operation dependent or independent of one another. Furthermore, the audio output elements 5a-5d can, dependent or independent of one another, be operated with identical or different audio output parameters, such as e.g. intensity.

The device 2 also comprises a control apparatus 6 implemented via hardware and/or software assignable or assigned to the audio output apparatus 5. The control apparatus 6 is configured to control the output of the audio signal 3 via respective audio output elements 5a-5d. In particular, the control apparatus 6 is configured to control at least one audio output parameter, i.e. e.g. the intensity of the audio signal 3 that can be output via respective audio output elements 5a-5d.

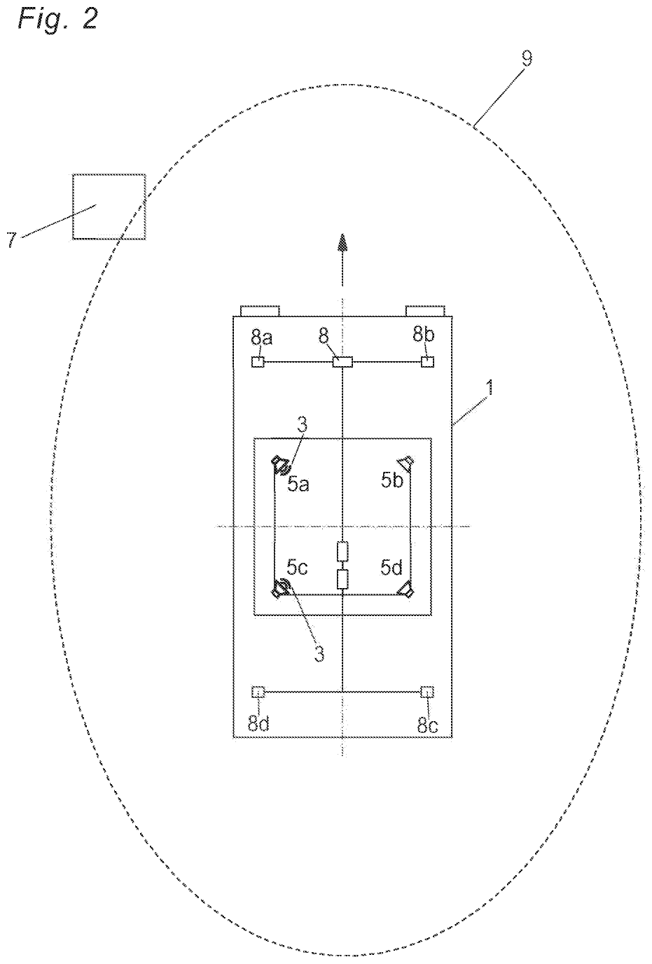

The control apparatus 6 is configured to control the output of the audio signal 3 into the passenger compartment 4 based on movement information describing a movement of at least one object 7 (see FIGS. 2-5), i.e. in particular another road user such as e.g. another motor vehicle, relative to the motor vehicle 1. The output of the audio signal 3 into the passenger compartment 4, i.e. in particular the output direction of the audio signal 3, understood here is in particular the output direction of the audio signal 3 output into the passenger compartment 4 acoustically felt or perceived by a passenger located in the passenger compartment 4, can therefore be controlled based on the movement information describing a movement of an object 7 located in the environment around the motor vehicle 1 relative to the motor vehicle 1. The control apparatus 6 is therefore configured to generate control parameters to control the output of the audio signal 3 to be output into the passenger compartment 4, which imparts to a vehicle passenger an acoustically perceivable connection between an object 7 located in the environment around the motor vehicle 1 and moving relative to the motor vehicle 1 or the movement of the object 7 located in the environment around the motor vehicle 1 relative to the motor vehicle 1 and the motor vehicle itself 1 and to perform the output of the audio signal 3 based on the control parameters. The output of the audio signal 3 therefore represents any objects 7 located in the environment around the motor vehicle 1 and moving relative to the motor vehicle 1. The mentioned, acoustically perceivable connection between objects 7 located in the environment around the motor vehicle 1 and moving relative to the motor vehicle 1 or corresponding objects 7 relative to the motor vehicle 1 and the motor vehicle 1 is therefore imparted to a vehicle passenger via the particular control of the output of the audio signal 3. This takes place independent of the actual content of the audio signal 3 only via the control of the output or the output direction of the audio signal 3; the actual content of the audio signal 3 is not changed.

The control of the output of the audio signal 3, i.e. in particular the control of the output direction of the audio signal 3 can therefore be imparted to a vehicle passenger in the sense of acoustically perceivable feedback that an object 7 located in the environment around the motor vehicle 1 is moving relative to the motor vehicle 1. Consequently, the control of the audio signal 3 can, in addition to the actual purpose of playing respective audio content represented by the audio signal 3, which is also provided during the control of the output of the audio signal 3, can also therefore be used through targeted control of the output direction to impart to a vehicle passenger, i.e. in particular the driver, the best possible information about objects 7 located in the environment around the motor vehicle 1 and moving relative to the motor vehicle 1.

In particular, objects 7 not visible to a vehicle passenger e.g. due a certain relative position to the motor vehicle 1 can be acoustically perceivable to the vehicle passenger by corresponding control of the output of the audio signal 3 such that the vehicle passenger is notified about non-visible objects 7 in the environment around the motor vehicle 1 by targeted control of the output or the output direction of the audio signal 3 taking place by means of the control apparatus 6. The control can carry out a targeted change of the output of the audio signals or the output direction of the audio signal 3 on the basis of which a vehicle passenger can be notified about a non-visible object 7 in the environment around the motor vehicle 1.

Driving safety-related aspects about the object situation in the environment around the motor vehicle 1 can therefore be imparted to the vehicle passenger via the output of the audio signal 3 dynamically or variably controllable or controlled based on the object situation in the environment around the motor vehicle 1.

The control apparatus 6 is assigned to an on-board detection apparatus 8 implemented via hardware and/or software, which is configured to detect a movement of an object 7 relative to the motor vehicle 1 and to generate (the) movement information describing a movement of at least one detected object 7 relative to the motor vehicle 1. The detection apparatus 8 is in particular configured to detect objects 7 moving in the same or opposing direction to the motor vehicle 1. The detection apparatus 8 can also be configured for distance or speed measurement. The detection apparatus 8 can form a part of an on-board assistance or safety system, i.e. e.g. a longitudinal and/or transverse guidance system, parking system etc. In particular, the detection apparatus 8 can form a part of an assistance system enabling a partially or fully autonomous drive operation of the motor vehicle 1. A corresponding assistance or safety system can have suitable e.g. acoustic and/or optical detection elements 8a-8d, i.e. e.g. acoustic and/or optical sensor elements, which are configured to detect objects in the environment around the motor vehicle 1 or to detect the movement of objects 7 in the environment around the motor vehicle 1. Corresponding detection elements 8a-8d can e.g. be designed as ultrasonic elements, laser elements, lidar elements, radar elements, etc.

The detection apparatus 8 is therefore configured to generate a detection region 9 surrounding the motor vehicle 1 (see FIGS. 2-5) in which a movement of an object 7 relative to the motor vehicle 1 is detectable. The detection apparatus 8 can be configured to detect the entry or the entry position and the exit or the exit position of corresponding objects 7 into the or from the detection region 9. Of course, movements of an object 7 occurring in the detection region 9 can also be detected within the detection region 9. The detection region 9, i.e. in particular its alignment, shape and size are based on the type, arrangement and mode of operation of the detection elements 8a-8d, of which four are shown purely by way of example in the exemplary embodiment shown in FIG. 1.

In relation to the exemplary embodiments shown in FIGS. 2-5, which each show a main representation of an exemplary object situation in the environment around the motor vehicle 1, exemplary object situations around the motor vehicle 1 described by corresponding movement information and possibilities of control of the output or the output direction of an audio signal 3 into the passenger compartment 4 of the motor vehicle 1 that can be or is carried out by means of the control apparatus 6 are explained below.

On the basis of the exemplary embodiment according to FIG. 2, it is discernible that the control apparatus 6, for the case of an object 7 moving left of the motor vehicle 1, is e.g. configured to control or carry out the output of an audio signal 3 to be output based on movement information describing a movement of the object 7 moving left of the motor vehicle 1 via audio output elements 5a, 5c arranged left of the longitudinal middle axis LA of the motor vehicle 1. The control apparatus 6 can in this case be configured to control or carry out the output of the audio signal 3 via audio output elements 5a, 5c arranged left of the longitudinal middle axis LA of the motor vehicle 1 with a comparatively higher intensity than audio output elements 5b, 5d arranged right of the longitudinal middle axis LA of the motor vehicle 1. It can therefore be imparted in an acoustically perceivable manner to the vehicle passenger that an object 7, in relation to the direction of travel of the motor vehicle 1 indicated in FIGS. 2-5 by the arrow, is located left of the motor vehicle 1 and is moving relative to the motor vehicle 1. The same can also be implemented with a comparatively lower intensity.

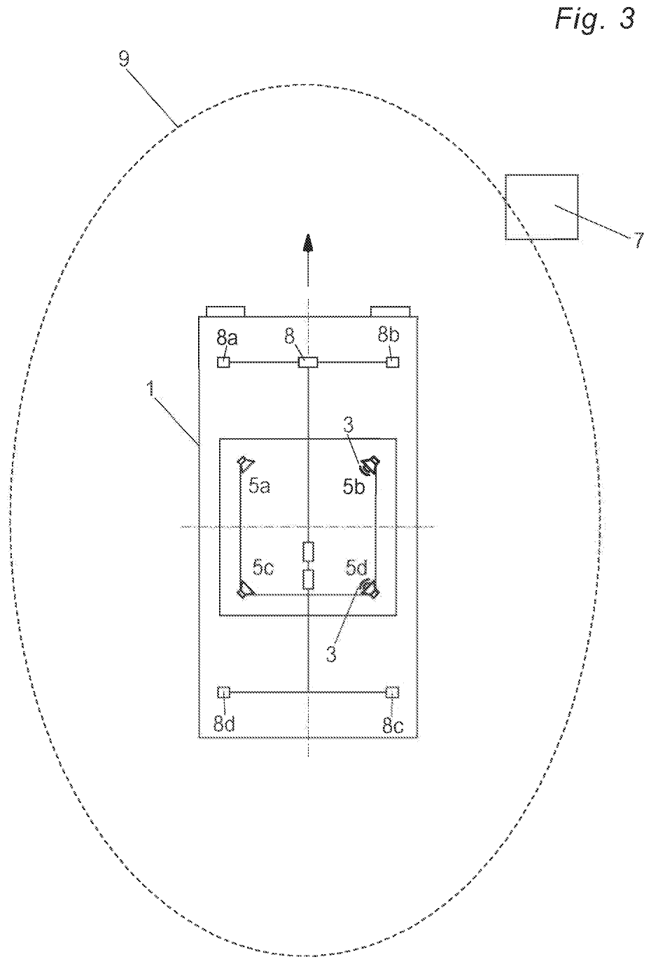

On the basis of the exemplary embodiment according to FIG. 3, it is discernible that the control apparatus 6, for the case of an object 7 moving right of the motor vehicle 1, is e.g. configured to control or carry out the output of an audio signal 3 to be output based on movement information describing a movement of the object 7 moving right of the motor vehicle 1 via audio output elements 5a, 5c arranged right of the longitudinal middle axis LA of the motor vehicle 1. The control apparatus 6 can in this case be configured to control or carry out the output of the audio signal 3 via audio output elements 5b, 5d arranged right of the longitudinal middle axis LA of the motor vehicle 1 with a comparatively higher intensity than via audio output elements 5a, 5c arranged left of the longitudinal middle axis LA of the motor vehicle 1. It can therefore be imparted in an acoustically perceivable manner to the vehicle passenger that an object 7, in relation to the direction of travel of the motor vehicle 1 indicated by the arrow, is located right of the motor vehicle 1 and is moving relative to the motor vehicle 1. The same can also be implemented with a comparatively lower intensity

It is also the case for the exemplary embodiments according to FIG. 2, 3 that the output of the audio signal 3 can take place based on movement information describing a movement of an object 7 moving towards the front of the motor vehicle 1 via the audio output elements 5a, 5b arranged in front of the transverse middle axis QA of the motor vehicle 1 and therefore in the region of the front of the motor vehicle 1. The control apparatus 6 can be configured to control or carry out the output of the audio signal 3 via the audio output elements 5a, 5b arranged in front of the transverse middle axis QA of the motor vehicle 1 with an intensity higher compared to a predefinable or predefined reference intensity than via the audio output elements 5c, 5d arranged behind the transverse middle axis QA of the motor vehicle 1 and therefore in the region of the rear of the motor vehicle 1. It is also the case here that the same can be implemented, if necessary, also with a comparatively lower intensity. Equally, the output of the audio signal 3 could take place conversely initially via audio output elements 5c, 5d arranged behind the transverse middle axis QA of the motor vehicle 1 and therefore in the region of the rear of the motor vehicle 1.

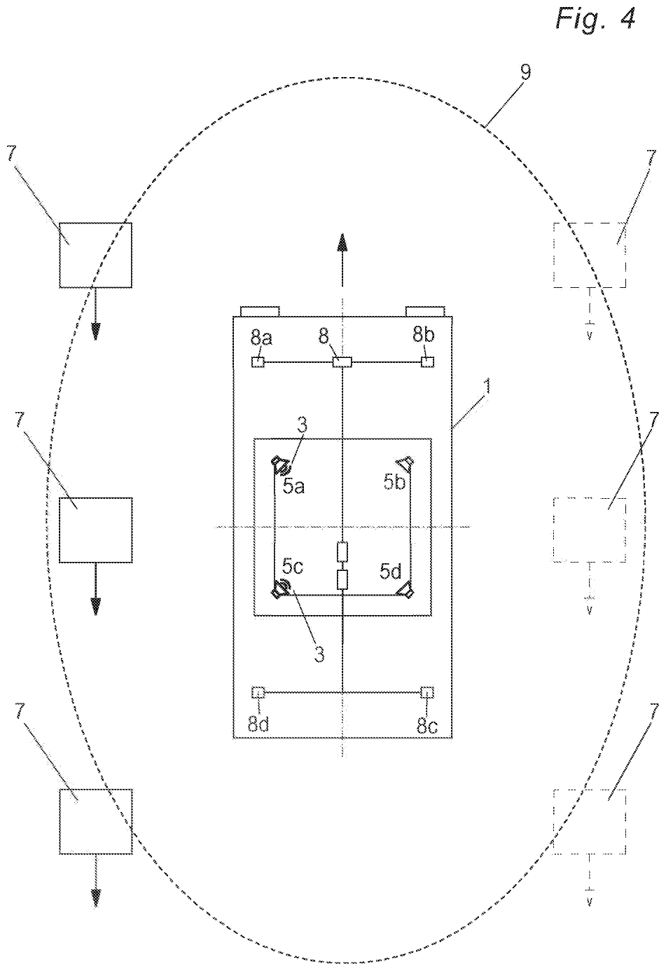

The control apparatus 6 can, as shown by way of example in FIG. 4, for the case of an object 7 moving, in relation to the direction of travel of the motor vehicle 1, from the left towards the motor vehicle 1, be configured to control the output of the audio signal 3 such that the audio signal 3 can be or is output, in particular prior to passing of the motor vehicle 1, only via at least one audio output element 5a arranged in the direction of travel in front of the transverse middle axis QA and left of the longitudinal middle axis LA, then, in particular during passing of the motor vehicle 1, via audio output elements 5a, 5c arranged in front of the transverse middle axis QA and at least one behind the transverse middle axis QA and left of the longitudinal middle axis LA and lastly, in particular after passing of the motor vehicle 1 only via at least one audio output element 5c arranged in the direction of travel behind the transverse middle axis QA and left of the longitudinal middle axis LA. Equally, the output of the audio signal 3 could take place conversely initially via an audio output element 5d arranged behind the transverse middle axis QA and therefore in the region of the rear of the motor vehicle 1. The same applies to the case, represented with a dashed line in FIG. 4, of an object 7 moving, in relation to the direction of travel of the motor vehicle 1, from the right towards the motor vehicle 1.

For the case of an object 7 moving away from the motor vehicle 1, the output of the audio signal 3 can take place based on movement information describing a movement of an object moving away from the motor vehicle via audio output elements 5c, 5d arranged behind a transverse middle axis QA and therefore in the region of the rear of the motor vehicle 1. The control apparatus 6 can be configured to control or carry out the output of the audio signal 3 based on movement information describing a movement of the object 7 moving away from the motor vehicle 1 via audio output elements 5c, 5d arranged behind the transverse middle axis QA with an intensity higher compared to a predefinable or predefined reference intensity than via audio output elements 5a, 5b arranged in front of the transverse middle axis QA and therefore in the region of the front of the motor vehicle 1. It is also the case here that the same can be implemented, if necessary, also with a comparatively lower intensity. Equally, the output of the audio signal 3 could take place conversely initially via audio output elements 5a, 5b arranged in front of the transverse middle axis QA and therefore in the region of the front of the motor vehicle 1.

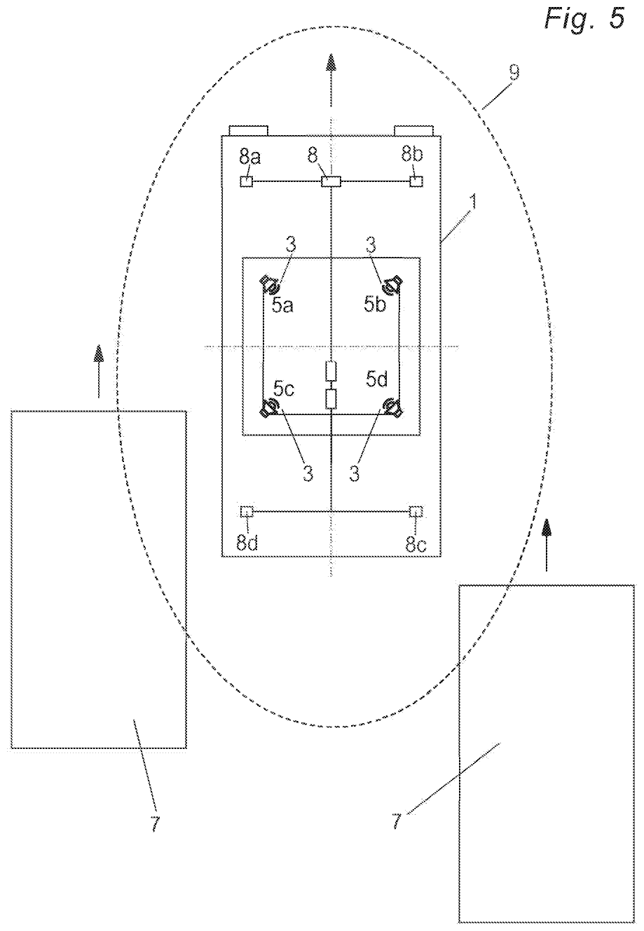

As shown in relation to the exemplary embodiment according to FIG. 5, the control apparatus 6 can also be configured to represent, in an acoustically perceivable manner to a vehicle passenger, left and right overtake operations of the motor vehicle 1 itself, i.e. situations in which the motor vehicle itself 1 overtakes an object 7, through a targeted control of the output or the output direction of the audio signal 3.

The control apparatus 6 can be configured, for a left overtake operation of the motor vehicle 1, to control the output of the audio signal 3 based on an object 7 to be overtaken or overtaken by the motor vehicle 1 on the left such that the audio signal 3 initially, in particular prior to passing of the object 7 to be overtaken on the left, is output only via an audio output element 5a arranged in the direction of travel in front of the transverse middle axis QA and left of the longitudinal middle axis LA, therefore, in particular during passing of the object 7 to be overtaken via audio output elements 5a, 5c arranged in front and one behind the transverse middle axis QA and left of the longitudinal middle axis LA and lastly, in particular after passing the object 7 to be overtaken, only via an audio output element 5c arranged in the direction of travel behind the transverse middle axis QA and left of the longitudinal middle axis LA. Equally, the output of the audio signal 3 could take place conversely initially via an audio output element 5c arranged behind the transverse middle axis QA and lastly via an audio output element 5a arranged in front of the transverse middle axis QA. The same applies to the case, represented with a dashed line in FIG. 5, of an object 7 to be overtaken or overtaken on the right.

Object or traffic situations may arise in which objects 7 located left and right of the motor vehicle 1 are moving towards or away from the motor vehicle 1. The control apparatus 6 can, in particular for such cases, be configured to control the output of the audio signal 3 based on an object 7 moving in the direction of travel of the motor vehicle 1 from the left towards or away from the motor vehicle 1 and an object 7 moving from the right towards or away from the motor vehicle 1 such that the output of the audio signal 3 takes place prioritized via audio output elements 5a-5d arranged left or right of the longitudinal middle axis LA. The prioritization can take place e.g. based on a classification of the objects 7. To this end, the motor vehicle 1 comprises a classification apparatus (not shown) implemented via hardware and/or software which can form a part of the control apparatus 6. The classification can take place based on detected object parameters, such as e.g. type, size, speed, acceleration, etc. of the object 7. It is also conceivable that the classification takes into account conditions of traffic law, such as e.g. left or right traffic.

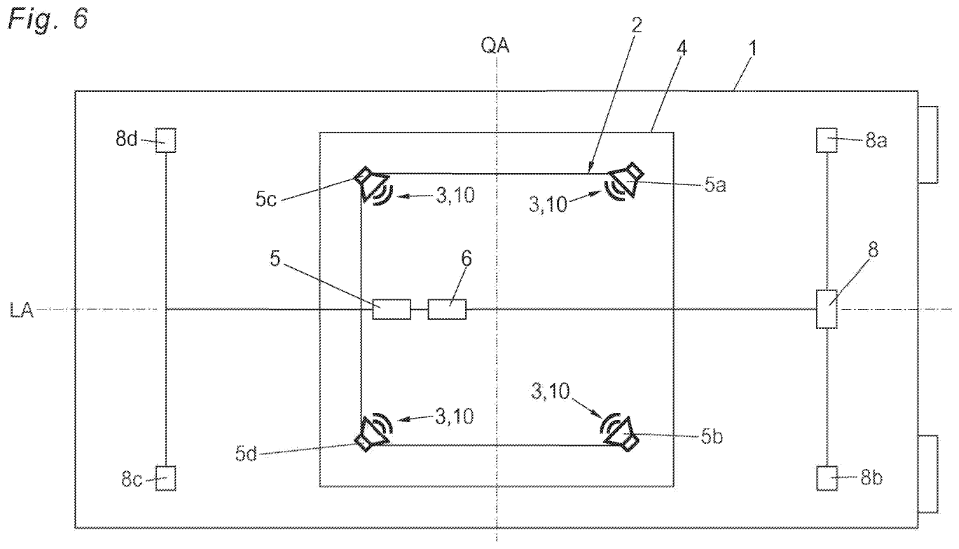

FIG. 6 shows a main representation of a motor vehicle 1 according to a further exemplary embodiment.

On the basis of the exemplary embodiment according to FIG. 6, it is initially discernible that the audio output apparatus 5 can be configured to output at least two different audio signals 3, 10 in particular in parallel or at the same time into the passenger compartment 4 of the motor vehicle 1. Irrespective of its specific content, respective first and second audio signals 3, 10 can be output via identical or different audio output elements 5a-5d and/or using identical or differing audio output parameters.

A first audio signal 3 can be a music or voice signal mentioned in relation to the exemplary embodiment according to FIG. 1. A second audio signal 10 can be an in particular artificially generated movement information signal which contains audio content other than music and/or voice, i.e. no music and/or voice. The movement information signal can e.g. in the form of a tone or a tone sequence of a certain frequency or a certain frequency range, indicate or describe a movement of at least one object 7, in particular another road user, relative to the motor vehicle 1. A movement information signal may therefore be an audio signal which is generated separately or additionally and output additionally with respect to an already output audio signal 3, which serves to indicate to a vehicle passenger a movement of at least one object 7, in particular relative to the motor vehicle 1. A movement information signal can therefore (only) be generated and/or output, in particular in contrast to a music and/or voice signal, when an object 7 moving relative to the motor vehicle 1 has been detected.

A movement information signal can be generated via the control apparatus 6.

The control apparatus 6 can also be configured to control the output of a corresponding movement information signal into the passenger compartment 4 based on the movement information describing a movement of at least one object 7, in particular a road user, relative to the motor vehicle 1. Therefore, the embodiments in relation to FIGS. 2-5 apply analogously to the control of the output of a movement information signal or the control of the output direction of a movement information signal. Therefore, the output or control of the output of a corresponding movement information signal, i.e. in particular the control of the output direction of the movement information signal can also be imparted to a vehicle passenger in the sense of acoustically perceivable feedback that an object 7 located in the environment around the motor vehicle 1 is moving relative to the motor vehicle 1.

Of course, the exemplary embodiments according to FIGS. 1 and 6 can be combined with one another. Therefore, the output of a plurality of different audio signals 3, 10, i.e. in particular of a corresponding movement information signal and a music and/or voice signal, can also in each case be controlled based on the movement information describing a movement of at least one object 7 relative to the motor vehicle 1.

For all exemplary embodiments, the control apparatus 6 can be configured to uninterruptedly perform a change of the output of the audio signal 3 taking place or carried out as part of the control of the output of the audio signal 3 from an output via at least one first audio output element 5a-5d to an output via at least one second audio output element 5a-5d. The change of the output of the audio signal 3 via one or a plurality of audio output elements 5a-5d can therefore in particular take place or be carried out by fading, i.e. a continuous change of intensity, i.e. an increase in intensity or reduction in intensity from a first intensity value to a second intensity value.

Also for all exemplary embodiments, the movement information can describe an acceleration or speed or an associated movement value of an object 7 moving relative to the motor vehicle 1. The control apparatus 6 can be configured to control the output of an audio signal 3 based on the acceleration or speed or an associated movement value describing the movement information in particular such that, in regard to a predefinable or predefined reference acceleration or speed, higher accelerations or speeds of an object 7 moving relative to the motor vehicle 1 are output with an output of the audio signal 3 with a higher intensity compared to a predefinable or predefined reference intensity.

Also for all exemplary embodiments, audio signals 3 can be output with a certain audio effect representing in particular the movement of a detected object moving relative to the motor vehicle. A corresponding audio effect can e.g. be an (artificially generated) Doppler effect. The audio effects can also be generated by the control apparatus 6.

A method for outputting at least one audio signal 3 into a passenger compartment 4 of a motor vehicle 1 can be implemented with the motor vehicles 1 shown in the Fig. According to the method, control of the output of the at least one audio signal 3 into the passenger compartment 4 takes place based on movement information describing a movement of at least one object 7, in particular another road user, relative to the motor vehicle 1.

1. A motor vehicle (1), comprising a device (2) for outputting an audio signal (3) into a passenger compartment (4) of the motor vehicle (1) which comprises:
an audio output apparatus (5) comprising a plurality of audio output elements (5a-5d) arranged in the passenger compartment (4) of the motor vehicle (1) for outputting at least one audio signal (3) into the passenger compartment (4) of the motor vehicle (1), a control apparatus (6) assignable or assigned to the audio output apparatus (5) for controlling the output of the at least one audio signal (3) via respective audio output elements (5a-5d), wherein:
the control apparatus (6) is configured to control the output of the at least one audio signal (3) into the passenger compartment (4) of the motor vehicle (1) based on movement information describing a movement of at least one object (7) relative to the motor vehicle (1).

2. The motor vehicle according to claim 1, wherein the audio output apparatus (5) is configured to output at least two different audio signals (3) into the passenger compartment (4) of the motor vehicle (1).

3. The motor vehicle according to claim 2, wherein a first audio signal (3) is a music or voice signal and a second audio signal (3) is a movement information signal generated by the control apparatus (6).

4. The motor vehicle according to claim 3, wherein the control apparatus (6) is configured to control at least the output of the movement information signal into the passenger compartment (4) of the motor vehicle (1) based on movement information describing a movement of at least one object (7) relative to the motor vehicle (1).

5. The motor vehicle according to claim 1, further comprising a detection apparatus (8) assignable or assigned to the control apparatus (6) which is configured to detect a movement of at least one object (7) relative to the motor vehicle (1) and to generate the movement information describing a movement of at least one detected object (7) relative to the motor vehicle (1).

6. A device according to claim 5, wherein the detection apparatus (8) is configured to generate a detection region (9) at least in sections surrounding the motor vehicle (1) in which a movement of at least one object (7) relative to the motor vehicle (1) is detectable.

7. The motor vehicle according to claim 1, wherein the detection apparatus (8) is configured to detect objects (7) moving in the same or opposing direction to the motor vehicle (1) relative to the motor vehicle (1).

8. The motor vehicle according to claim 1, wherein the control apparatus (6) is configured to control the output of an audio signal (3) to be output based on movement information describing a movement of an object (7) moving left of the motor vehicle (1) via audio output elements (5a-5d) arranged left of a longitudinal middle axis (LA) of the motor vehicle (1) via audio output elements (5a-5d) arranged left of a longitudinal middle axis (LA) of the motor vehicle (1) with a comparatively higher intensity than via audio output elements (5a-5d) arranged right of the longitudinal middle axis (LA) of the motor vehicle (1).

9. The motor vehicle according to claim 1, wherein the control apparatus (6) is configured to control the output of an audio signal (3) to be output based on movement information describing a movement of an object (7) moving right of the motor vehicle (1) via audio output elements (5a-5d) arranged right of a longitudinal middle axis (LA) of the motor vehicle (1) via audio output elements (5a-5d) arranged right of a longitudinal middle axis (LA) of the motor vehicle (1) with a comparatively higher intensity than via audio output elements (5a-5d) arranged left of the longitudinal middle axis (LA) of the motor vehicle (1).

10. The motor vehicle according to claim 1, wherein the control apparatus (6) is configured to control the output of an audio signal (3) to be output based on movement information describing a movement of an object (7) moving towards the front of the motor vehicle (1) via audio output elements (5a-5d) arranged in front of a transverse middle axis (QA) of the motor vehicle (1) with an intensity higher compared to a predefinable or predefined reference intensity than via audio output elements (5a-5d) arranged behind the transverse middle axis (QA) of the motor vehicle (1).

11. The motor vehicle according to claim 1, wherein the control apparatus (6) is configured to control the output of an audio signal (3) to be output based on movement information describing a movement of an object (7) moving away from the motor vehicle (1) via audio output elements (5a-5d) arranged behind a transverse middle axis (QA) of the motor vehicle (1) with an intensity higher compared to a predefinable or predefined reference intensity than via audio output elements (5a-5d) arranged in front of the transverse middle axis (QA) of the motor vehicle (1).

12. The motor vehicle according to claim 1, wherein the control apparatus (6) is configured to control the output of an audio signal to be output based on movement information describing a movement of an object (7) moving in the direction of travel from the left towards the motor vehicle (1) such that the audio signal (3) can be or is output, initially prior to passing of the motor vehicle (1), only via audio output elements (5a-5d) arranged in the direction of travel in front of the transverse middle axis and left of the longitudinal middle axis of the motor vehicle (1), therefore during passing of the motor vehicle (1), via audio output elements arranged in front of and behind the transverse middle axis (QA) and left of the longitudinal middle axis (LA) of the motor vehicle (1), and lastly after passing of the motor vehicle (1), only via audio output elements (5a-5d) arranged in the direction of travel behind the transverse middle axis (QA) and left of the longitudinal middle axis (LA) of the motor vehicle (1).

13. The motor vehicle according to claim 1, wherein the control apparatus (6) is configured to control the output of an audio signal (3) to be output based on movement information describing a movement of an object (7) moving in the direction of travel from the right towards the motor vehicle (1) such that the audio signal (3) can be or is output, initially prior to passing of the motor vehicle (1), only via audio output elements (5a-5d) arranged in the direction of travel in front of the transverse middle axis (QA) and right of the longitudinal middle axis (LA) of the motor vehicle (1), therefore during passing of the motor vehicle (1), via audio output elements (5a-5d) arranged in front of and behind the transverse middle axis (QA) and right of the longitudinal middle axis (LA) of the motor vehicle (1), and lastly after passing of the motor vehicle (1) only via audio output elements (5a-5d) arranged in the direction of travel behind the transverse middle axis (QA) and right of the longitudinal middle axis (LA) of the motor vehicle (1).

14. The motor vehicle according to claim 1, wherein the control apparatus (6) is configured to control the output of an audio signal (3) to be output based on movement information describing a movement of a moving object (7) to be overtaken or overtaken to the left by the motor vehicle (1) such that the audio signal (3) can be or is output, initially prior to passing of the motor vehicle (1), only via audio output elements (5a-5d) arranged in the direction of travel behind the transverse middle axis (QA) and left of the longitudinal middle axis (LA) of the motor vehicle (1), therefore during passing of the object (7) to be overtaken, via audio output elements (5a-5d) arranged in front of and behind the transverse middle axis (QA) and left of the longitudinal middle axis (LA) of the motor vehicle (1), and lastly after passing of the object (7) to be overtaken only via audio output elements (5a-5d) arranged in the direction of travel in front of the transverse middle axis (QA) and left of the longitudinal middle axis (LA) of the motor vehicle (1).

15. The motor vehicle according to claim 1, wherein the control apparatus (6) is configured to control the output of an audio signal (3) to be output based on movement information describing a movement of a moving object (7) to be overtaken or overtaken to the right by the motor vehicle (1) such that the audio signal (3) can be or is output, initially prior to passing of the motor vehicle (1), only via audio output elements (5a-5d) arranged in the direction of travel behind the transverse middle axis (QA) and right of the longitudinal middle axis (LA) of the motor vehicle (1), therefore during passing of the object (7) to be overtaken, via audio output elements (5a-5d) arranged in front of and behind the transverse middle axis (QA) and right of the longitudinal middle axis (LA) of the motor vehicle (1), and lastly after passing of the object (7) to be overtaken only via audio output elements (5a-5d) arranged in the direction of travel in front of the transverse middle axis (QA) and right of the longitudinal middle axis (LA) of the motor vehicle (1).

16. The motor vehicle according to claim 1, wherein the control apparatus (6) is configured to uninterruptedly perform the output of an audio signal (3) to be output from an output of the audio signal (3) via a first audio output element (5a-5d) to an output of the audio signal (3) via at least one second audio output element (5a-5d).

17. The motor vehicle according to claim 1, wherein the control apparatus (6) is configured to control the output of an audio signal (3) to be output based on movement information describing a movement of an object (7) moving in the direction of travel from the left towards or away from the motor vehicle (1) and an object (7) moving from the right towards or away from the motor vehicle (1) such that the output of an audio signal (3) takes place prioritized via audio output elements (5a-5d) arranged left or right of the longitudinal middle axis (LA) of the motor vehicle (1).

18. The motor vehicle according to claim 1, wherein the movement information describes an acceleration or speed, of an object (7) moving relative to the motor vehicle (1), wherein the control apparatus (6) is configured to control the output of the audio signal (3) into the passenger compartment (4) of the motor vehicle (1) based on an acceleration or speed, described by the movement information, of the object (7) moving relative to the motor vehicle (1) such that in regard to a predefinable or predefined reference acceleration or speed, higher accelerations or speeds of an object (7) moving relative to the motor vehicle (1) are output with an output of the audio signal (3) with a higher intensity compared to a predefinable or predefined reference intensity.

19. A device (2) for outputting at least one audio signal (3) into a passenger compartment (4) of a motor vehicle (1), comprising:
an audio output apparatus (5) comprising a plurality of audio output elements (5a-5d) arrangeable or arranged in a passenger compartment (4) of a motor vehicle (1) equipped with the device (1) for outputting at least one audio signal (3) into a passenger compartment (4) of a motor vehicle (1),
a control apparatus (6) assignable or assigned to the audio output apparatus (5) for controlling the output of an audio signal (3) via respective audio output elements (5a-5d), wherein the control apparatus (6) is configured to control the output of at least one audio signal (3), into a passenger compartment (4) of a motor vehicle (1) equipped with the device (2) based on movement information describing a movement of at least one object (7), in particular a road user, relative to the motor vehicle (1) equipped with the device (2).

20. A method for outputting at least one audio signal (3) into a passenger compartment (4) of a motor vehicle (1) according to claim 1, wherein a control of the output of the at least one audio signal (3) into the passenger compartment (4) of the motor vehicle (1) takes place based on movement information describing a movement of at least one object (7) relative to the motor vehicle (1).
